(19) United States
(12) Patent Application Publication
(10) Pub. No.: US 2007/0059141 A1
(43) Pub. Date: Mar. 15, 2007

(54) Hoisting and transporting apparatus for disabled persons

(75) Inventor: Knud Raun, Vejle (DK)

Correspondence Address: James C Wray, Suite 300, 1493 Chain Bridge Road, McLean, VA, 22101, US

(73) Assignee: Kund Raun

(21) Appl. No.: 10/577,546

(22) PCT Filed: Oct. 8, 2004
(86) PCT No.: PCT/DK04/00689

§ 371 Date: Sep. 11, 2006

(30) Foreign Application Priority Data
Oct. 30, 2003 (DK) PA 2003 00613

(51) Int. Cl. A01D 51/00

(52) U.S. Cl. 414/560

(57) ABSTRACT

An apparatus for hoisting and transporting a disabled person is made up of a frame having a top section supported by front and rear end sections, the frame being provided with swivelling wheels for horizontal movement. The frame is without framework in the lower part between the end sections and the top section is composed of mutually telescoping parts for adjusting the length between the end sections. Thereby it is possible to move the apparatus in between fixed seat rows, e.g. in an airplane, for taking up or putting down a disabled person that may be suspended from arms in a sling seat below the top section. Undesired and hazardous work positions on the part of aiding assistants are thus avoided as well as excessive strain on the assistants, and the disabled person is also provided a more dignified handling.

### FIELD OF THE INVENTION

The invention concerns an apparatus for hoisting and transporting a disabled person.

### BACKGROUND OF THE INVENTION

Such apparatuses are prior art. An example is disclosed in U.S. Pat. No. 4,003,479. This apparatus includes a frame supported by swivelling wheels, the frame including a substantially horizontally extending top section provided with substantially vertically extending end sections extending downwards at opposite ends of the top section, respectively, where the apparatus is arranged with a hoisting mechanism for supporting and hoisting the disabled person in a sling seat in the space under the top section and between the end sections of the frame.

The frame of the disclosed apparatus is rigid, and the lower ends of the end sections are interconnected by struts or rods, thus forming a permanent structure. The prior art apparatus is suited for lifting and transporting a disabled person over short distances by drawing along by an assistant. However, when the disabled person is to be mounted or dismounted from the seat-sling or harness member between the end sections, he has to be lifted manually in and out of the sling sideways. This causes great strain on the part of assistants doing the lifting and implies risk of injuries on the assistants, and it is cumbersome and as a whole not a very dignified way of handling a disabled person. Also, the configuration of the prior art apparatuses is so that is not possible to let is go in over a wheelchair or a normal chair in order to position the sling seat at or behind the disabled person for mounting him in the sling seat, or reversely, to place the disabled person over a normal chain or wheelchair in order to place the person there.

### ASPECTS OF THE INVENTION

One aspect of the invention is to provide an apparatus for hoisting and transporting a disabled person, where the apparatus can be placed around a sitting person for mounting the person in a sling seat suspended under the apparatus.

Another aspect of the invention is to provide an apparatus which can be placed around different kinds of sitting furniture.

A further aspect of the invention is to provide an apparatus as indicated above where a disabled person can be mounted in a sling seat even under conditions where space is very limited.

A still further aspect of the invention is to provide a hoisting and transporting apparatus as indicated above which is compact so as to drive around tight corners and tight spaces and which still can be adapted in length for operation between seat rows.

A still further aspect of the invention is to provide a hoisting and transporting apparatus which can be moved by an auxiliary drive unit.

A still further aspect of the invention is to provide a movable hoisting and transporting apparatus as indicated above having its own power supply.

### SUMMARY OF THE INVENTION

The apparatus according to the invention for hoisting and transporting a disabled person and as indicated in the introduction has the peculiar feature that most of the space from a base and upwards under the top section and between the end sections is accessible from at least one side of the frame, and that the top section of the frame is extendible in horizontal direction in such a way that the distance between the end sections can be adjusted.

As the space under the top section is accessible from one side, it is possible to dispose the apparatus over a seat, e.g. a wheelchair, while mounting a disabled person in the sling seat under the top section. The hoisting mechanism provided on the apparatus can thus be utilised for lifting the person up from the wheelchair or fixed seat and so avoid excess load and strain on the assistant helping the disabled person to change the seat. Sideways lifting by the assistant is avoided. After mounting the person, the wheelchair can be removed or, preferable the apparatus can be moved sideways on its swivelling wheels and away from the wheelchair. Since the top section is extendable in horizontal direction, it is possible to adapt the length of the apparatus so that it can reach around a wheelchair or fit between rows of chairs or fixed seat rows, while at the same time, after the mounting, to reduce the length of the apparatus for easy manoeuvring and moving the apparatus, e.g. around tight corners.

It is preferred that the top section is telescoping in the direction of extension so as to provide a simple construction for adjusting the length of the apparatus.

In order to further facilitate the work of assistants, the top section of the frame may be provided with at least one actuator for adjusting the length of the top section and thus the distance between the end sections.

In a preferred embodiment the extending/collapsing actuator may be powered by a motor connected to a rechargeable battery which is mounted at one of the end sections of the apparatus.

In order to provide a secure mounting and lifting of the person in the sling seat of the hoisting mechanism, it is preferred that that the hoisting mechanism is constituted by two lifting arms that are pivotably mounted at the top section of the frame, and where each lifting arm is provided with an actuator between arm and an adjacent end section of the frame.

The actuators for pivoting the arms may be driven by one motor powered by a rechargeable battery which is mounted on an adjacent end section of the frame.

For easy driving and still maintaining the compact structure of the apparatus, it is preferred that the frame of the apparatus is adapted for mounting a detachable battery powered driving unit with drive wheels. The drive unit may thus be mounted for pushing or hauling the hoisting and lifting apparatus over long distances, e.g. in airport terminals. When the apparatus is to be used in tight spaces or pushed in between seat rows, e.g. in an airplane, the drive unit may be dismounted.

A preferred embodiment of the mounting means for the drive unit includes a pair of hooks provided on an end section of the frame for engaging a transverse bar provided on the driving unit, also including attaching means provided below the hooks on the end section concerned and below the transverse bar on the driving unit for holding driving unit and end section together. The pair of hooks may thus engage the transverse bar on the driving unit and while the adjacent end section of the apparatus is lifted slightly, so as to rest on the drive wheels, the attaching means engage each other for holding the end section and the drive unit together.

It is preferred that the attaching means is a spring-biased snap lock consisting of a male locking member that may engage a female member with spring-biased retainer means. Simple and reliable attaching means are thereby provided for automatic engagement and simple manual disengagement.

In order to make the apparatus frame better fit between permanent seat rows, it is preferred that each end section is provided with at least one transverse bend along a horizontal line, so that the geometry of each end section provides an offset of the position of the pair of swivelling wheels of the end section from a vertical plane passing through the line of intersection of the end section and the top section.

### DESCRIPTION OF THE DRAWING

Embodiments of the invention will now be described with reference to the drawings, where:

FIG. 1 shows a perspective view of a preferred embodiment of the apparatus according to the invention, without drive unit and sling seat;

FIG. 2 shows a side view of the apparatus of FIG. 1, but with the drive unit fitted and showing power supply and remote controls;

FIG. 3 shows a drive unit for the apparatus according to the invention in perspective view; and

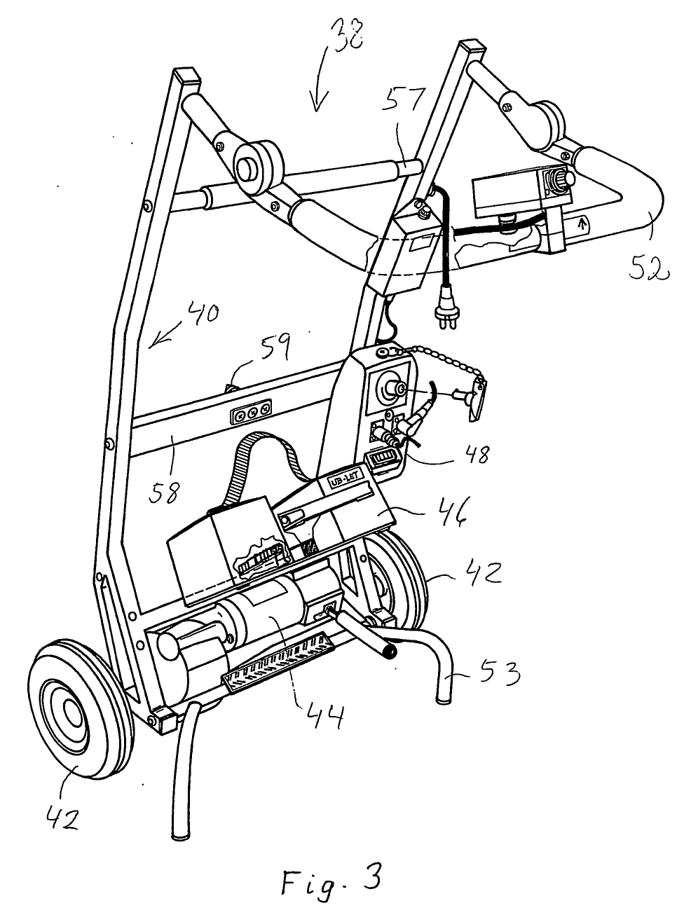

FIG. 4 shows a detail of a preferred embodiment of an attaching means for the drive unit.

### DETAILED DESCRIPTION OF EXAMPLE EMBODIMENTS

In the preferred embodiment, the apparatus according to the invention is designed for transporting and lifting disabled persons, e.g. wheelchair users, in places where it is not possible to go for a common wheelchair or other commonly known aids for disabled persons.

The apparatus is thus provided with a relatively narrow structure with an overall width which does not exceed 400 millimetres in its basic form which is suitable for most narrow gangways and for the persons transported by the apparatus.

In its basic form, the apparatus is provided with a frame with three main parts: a front end section 1, a rear end section 3 and a top section 5. In order to provide a light and easily constructed frame, the sections 1,3,5 are all made up of square pipes. At the bottom, the front and rear sections 1, 3 are each provided with a pair of swivelling wheels 7 so that the apparatus can move in any horizontal direction on an even base 8. At the top, the end sections 1, 3 are joined to the top section 5 by welding. Since there is no framework between the front and the rear end sections 1, 3 from the base and most of the way up to the top section 5, the joints at the top are reinforced by struts 9 between top section part 5b and rear end section 3. Also, the corner between top section part 5a and front end section 1 is strengthened by a triangular plate 11.

In order to make the apparatus adjustable in length, e.g. when moving the end sections 1,3 in between permanently fixed seat rows, the top section 5 is constituted by two mutually telescoping parts 5a and 5b. In order to provide the telescoping action without manual operation, which may be rather difficult when the apparatus is loaded, the parts 5a and 5b are interconnected by an electrically powered actuator 13. The actuator 13 is powered by a motor 14. The electric motor 14 is supplied with energy from a rechargeable battery 15 disposed at the top of front end section 1. The actuator 13 may be controlled by a handheld remote control 17 by a wire connection.

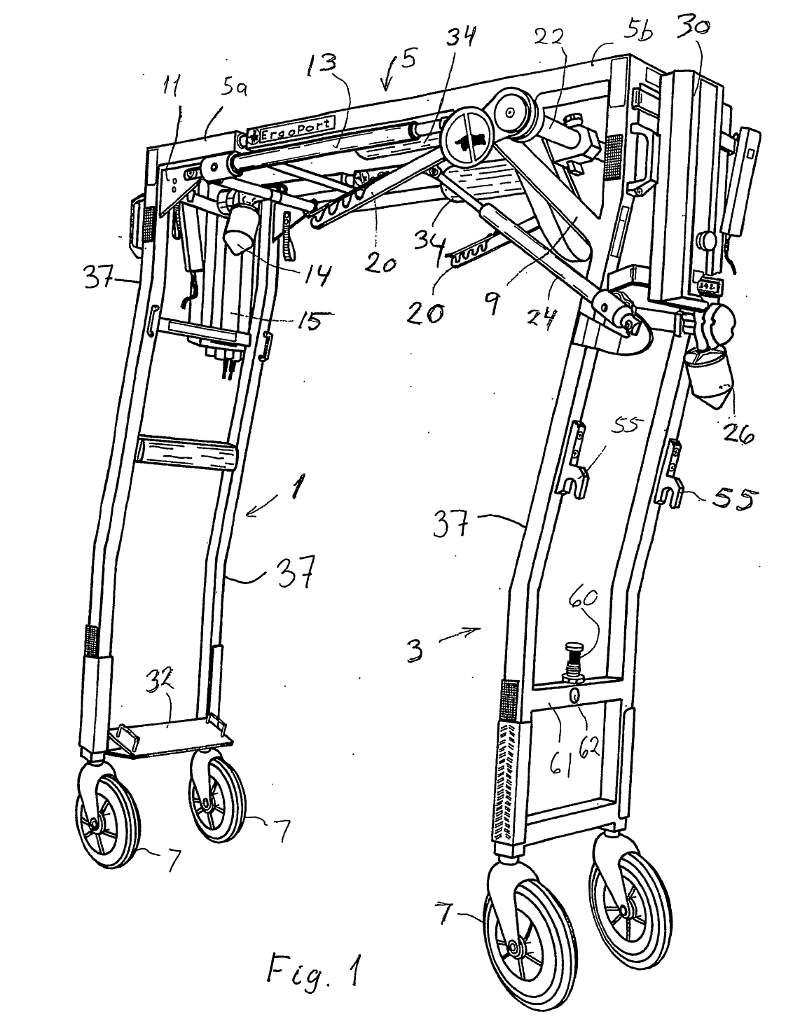

The apparatus is provided with a hoisting means 19 that includes two parallel arms 20 pivoting about a common axle 22. The arms 20 are pivoted by actuators 24 that are provided at each their side of rear end section 3 as shows on FIG. 1. The actuators 24 are driven by a common electric motor 26 coupled to the actuators 24 by a transmission known by the skilled in the art, e.g. as made by LINAK Danmark A/S, of Silkeborg, Denmark. The motor 26 is also operated by a handheld remote control 28 and supplied with energy with a rechargeable battery 30 mounted on rear end section 3. With the remote control 28 it is thus possible for an assistant to lift and lower a disabled person suspended in a sling seat or similar harness member hanging from the free ends of the arms 20. The lifting capability may be so that it is possible to lift the disabled person over a fixed armrest on the permanent seat or chair, thus providing a clear advantage compared with the manual handling by assistants who have to move the disabled person sideways while carrying him.

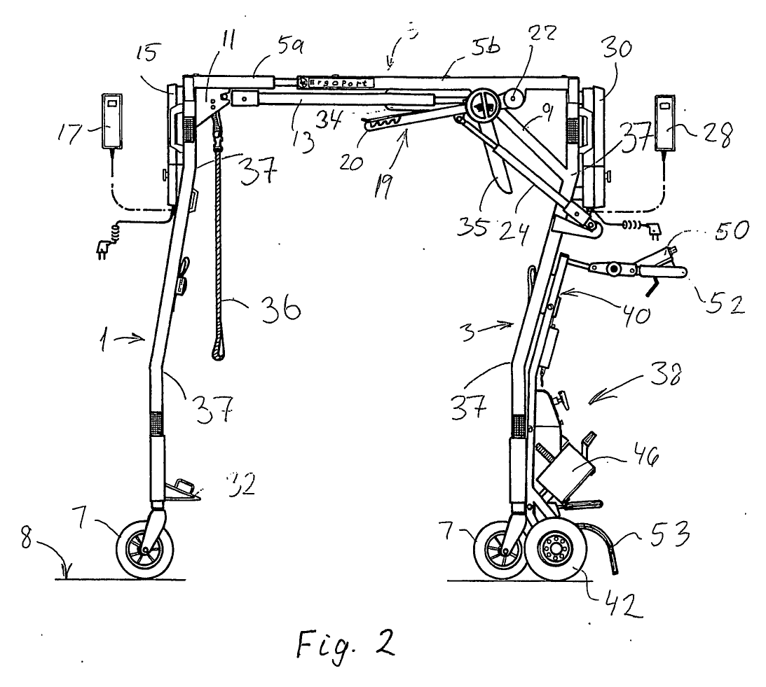

A sling seat is not shown in the drawing, but various known models may be applied. Straps 36 may be provided at the corner between sections Sa and 1, as shown on FIG. 2, for attaching to and for stabilising the sling seat when carrying a disabled person.

In order that the apparatus can fit between seat rows, e.g. in an airplane, and for minimising space requirement, the end sections 1 and 3 are each provided with two bends 37 about horizontal lines so that the wheels 7 are offset from the vertical plane passing through the intersection between top section 5 and end sections 1 and 3, respectively.

Preferably, the apparatus according to the invention is also provided with a foot rest 32 for the disabled person suspended in the apparatus at the bottom of front end section 1. For comfort and for safety reasons, the apparatus is also provided with protective padding 34 and a head guard 35 under the top section 5.

Also, the apparatus according to the invention is preferably, but not necessarily, adapted for mounting an auxiliary drive unit 38 to provide a combined self-propelled hoisting and lifting apparatus according to the invention. Basically, the drive unit 38 is made up of an upright frame 40 provided with a pair of drive wheels 42 at the bottom. The drive wheels 42 are powered by an electric motor 44 with a rechargeable battery 46. The motor 44 is controlled through a switchbox 48 and control unit 50 disposed on a handle bar 52 at the top of the frame 40. Support legs 53 at the bottom of the drive unit enable the drive unit to stand by itself when not in use.

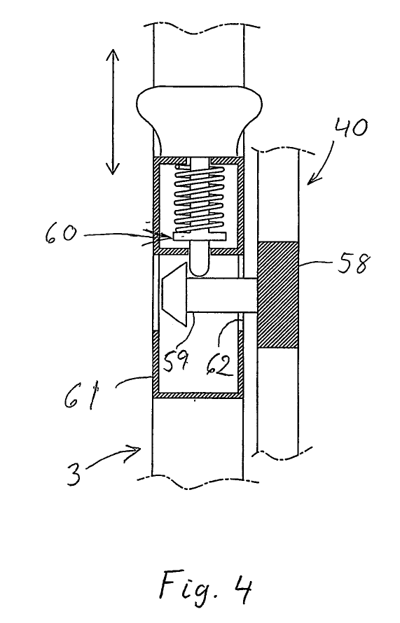

For attaching the drive unit 38 to an end section, e.g. the rear end section 3, the latter is provided with downward facing hooks 55 for engaging an upper transverse bar 57 in the frame 41. When pushing the frame 41 with the bar 57 upwards in engagement with hooks 55, the rear end section 3 is lifted slightly from the ground while its weight is transferred via the drive unit 38 to the drive wheels 42 (see FIG. 2) and eventually the base 8. On a second transverse bar 58 below the bar 57, a snap lock comprising a male lock member 59 may engage a spring biased pin 60 mounted over a hole 62 on a transverse bar 61 of the end section 3, see FIG. 4. In that way, the drive unit 38 is integrated with the apparatus for driving the combined apparatus with its human load over long distances. Detachment of the drive unit 38 may be provided by reversed action, i.e. releasing the pin 60 by pulling its knob upwards and pulling the lower part of the drive unit 38 away rear end section 3, finally disengaging the bar 57 from hooks 55 so that end section 3 again rests on its wheels 7.

The apparatus according to the invention is suited for handling and transporting disabled persons in areas with little space and for aiding with transferring the disabled to and from a permanent seat, where it is difficult for assistants to handle the disabled person. However, other applications are possible, e.g. to and from beds and in other cases where handling by assistants is desired to be avoided.

1. Apparatus for hoisting and transporting a disabled person, including a frame supported by swivelling wheels, the frame including a substantially horizontally extending top section provided with substantially vertically extending end sections extending downwards at opposite ends of the top section, respectively, where the apparatus is arranged with a hoisting mechanism for supporting and hoisting the disabled person in a sling seat in the space under the top section and between the end sections of the frame, characterised in that most of the space from a base and upwards under the top section and between the end sections is accessible from at least one side of the frame, and that the top section of the frame is extendible in horizontal direction in such a way that the distance between the end sections can be adjusted.

2. Apparatus according to claim 1, wherein the top section of the frame is telescoping in the direction of extension.

3. Apparatus according to claim 1 or 2, wherein the top section of the frame is provided with at least one actuator which is arranged for adjusting the distance between the end sections.

4. Apparatus according to claim 3, wherein the at least one actuator is powered by a motor connected to a rechargeable battery which is mounted at one of the end sections.

5. Apparatus according to any preceding claim, wherein the hoisting mechanism is constituted by two lifting arms that are pivotably mounted at the top section of the frame, and where each lifting arm is arranged with an actuator between arm and an adjacent end section of the frame.

6. Apparatus according to claim 5, wherein a pair of actuators for pivoting the arms are driven by one motor, the motor being powered by a rechargeable battery mounted on the adjacent end section of the frame.

7. Apparatus according to any preceding claim, wherein the frame is adapted for mounting a detachable, battery-powered driving unit with drive wheels.

8. Apparatus according to claim 7, wherein the means for mounting the driving unit are constituted by a pair of hooks provided on an end section of the frame for engaging a transverse bar provided on the driving unit, and by attaching means provided below the hooks on the end section concerned and below the transverse bar on the driving unit for holding driving unit and end section together.

9. Apparatus according to claim 8, wherein the attaching means is a spring-biased snap lock consisting of a male locking member that may engage a female member with spring-biased retainer means.

10. Apparatus according to any preceding claim, wherein each end section is provided with at least one transverse bend along a horizontal line, so that the geometry of each end section provides an offset of the position of the pair of swivelling wheels of the end section from a vertical plane passing through the line of intersection of the end section and the top section.
